(19) United States
(12) Patent Application Publication
(10) Pub. No.: US 2020/0117208 A1
(43) Pub. Date: Apr. 16, 2020

(54) VEHICLE CONTROL APPARATUS AND METHOD THEREOF

(71) Applicant: MANDO CORPORATION, Pyeongtaek-si (KR)

(72) Inventors: HYEONG MIN WOO, Seongnam-si (KR); JAE SUK KIM, Yongin-si (KR)

(21) Appl. No.: 16/654,473

(22) Filed: Oct. 16, 2019

(30) Foreign Application Priority Data
Oct. 16, 2018 (KR) 10-2018-0123216

(51) Int. Cl. G05D 1/02; G05D 1/00; B60W 30/06; G08G 1/16

(52) U.S. Cl. CPC G05D 1/0238; G05D 1/0088; B60W 30/06; G05D 2201/0213; G08G 1/168; B60W 2550/10; G05D 1/0246

(57) ABSTRACT

Disclosed herein is a vehicle control apparatus and a method of controlling the vehicle. A vehicle control apparatus includes: a communicator configured to receive first information of a vehicle stopped in a station infrastructure and second information of a parking infrastructure; and a controller configured to set a driving path from the station infrastructure to the parking infrastructure based on the first information and the second information, to determine an initial behavior when the vehicle stopped in the station infrastructure starts based on the first information, and to control the vehicle stopped in the station infrastructure to drive along the driving path and park in the parking infrastructure.

### CROSS-REFERENCE TO RELATED APPLICATION(S)

This application is based on and claims priority under 35 U.S.C. § 119 to Korean Patent Application No. 10-2018-0123216, filed on Oct. 16, 2018 in the Korean Intellectual Property Office, the disclosure of which is incorporated by reference in its entirety.

### TECHNICAL FIELD

Embodiments of the disclosure relate to a vehicle control apparatus and a method of controlling a vehicle.

### BACKGROUND

Recently, a driver has a lot of interest in performance and convenience of a vehicle. As a demand for vehicle performance, driver comfort and safety increases, studies and developments regarding an Advanced Driver Assist System (ADAS) that controls the vehicle to assist the driver in driving the vehicle are consistently ongoing.

In particular, novice drivers and the elderly are generally difficult to park, so the driver can park more easily by a Smart Parking Assist System (SPAS). The SPAS may refer to a system that searches a parking space through sensors mounted on the vehicle as the vehicle slowly moves, calculates a movement trajectory to park the vehicle in the searched parking space, and guides the driver to stop the vehicle.

However, since the SPAS searches the parking space while the vehicle moves slowly, a time is delayed and the movement trajectory or a driving path for parking in the parking space is very limited. Thus, there is a problem that the driver is uncomfortable because the driver finally intervenes.

Accordingly, there is a demand for a technology for searching the driving path from a current vehicle position to a parking area without moving the vehicle and controlling the vehicle to autonomously drive and park in the parking area without the driver's intervention.

### SUMMARY

Therefore, it is an aspect of the disclosure to provide a vehicle control apparatus capable of providing driving convenience to a driver by controlling a vehicle to park autonomously, and a method of controlling the vehicle.

It is another aspect of the disclosure to provide a vehicle control apparatus capable of setting a driving path for accurately parking a parking area or a departure path for accurately reaching a departure area, and a method of controlling the vehicle.

Additional aspects of the disclosure will be set forth in part in the description which follows and, in part, will be obvious from the description, or may be learned by practice of the disclosure.

In accordance with an aspect of the disclosure, a vehicle control apparatus includes: a communicator configured to receive first information of a vehicle stopped in a station infrastructure and second information of a parking infrastructure; and a controller configured to set a driving path from the station infrastructure to the parking infrastructure based on the first information and the second information, to determine an initial behavior when the vehicle stopped in the station infrastructure starts based on the first information, and to control the vehicle stopped in the station infrastructure to drive along the driving path and park in the parking infrastructure. The first information may include position coordinates and a stop type of the vehicle obtained by a processing result of at least one of image data captured by an image sensor disposed in the station infrastructure and detecting data captured by a non-image sensor disposed in the station infrastructure. The first information may be transmitted to the communicator by a first wireless communication device disposed in the station infrastructure. The second information may include position coordinates of the station infrastructure and a type of the station infrastructure. The second information may be transmitted to the communicator by a second wireless communication device disposed in the parking infrastructure.

In accordance with another aspect of the disclosure, in an image sensor disposed a station infrastructure, configured to capture image data, the image data is configured to be used to generate information including the position coordinates of the vehicle calculated using the distance between the image sensor and the vehicle and the vehicle area that the vehicle occupies within the station infrastructure and the stop type determined by any one of the longitudinal stop, the transverse stop and the diagonal stop according to the turning angle of the vehicle with respect to the station infrastructure.

In accordance with another aspect of the disclosure, a method of controlling a vehicle includes: receiving, by a communicator, first information of a vehicle stopped in a station infrastructure and second information of a parking infrastructure; setting, by a controller, a driving path from the station infrastructure to the parking infrastructure based on the first information and the second information; determining, by the controller, an initial behavior when the vehicle stopped in the station infrastructure starts based on the first information; and controlling, by the controller, the vehicle stopped in the station infrastructure to drive along the driving path and park in the parking infrastructure. The first information may include position coordinates and a stop type of the vehicle obtained by a processing result of at least one of image data captured by an image sensor disposed in the station infrastructure and detecting data captured by a non-image sensor disposed in the station infrastructure. The first information may be transmitted to the communicator by a first wireless communication device disposed in the station infrastructure. The second information may include position coordinates of the station infrastructure and a type of the station infrastructure. The second information may be transmitted to the communicator by a second wireless communication device disposed in the parking infrastructure.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a vehicle control system according to embodiments of the disclosure;

FIG. 2 is a view illustrating a configuration of a vehicle control apparatus according to embodiments of the disclosure;

FIG. 3 is a view for describing an embodiment of determining position coordinates and a stop type of a vehicle positioned in a station infrastructure according to embodiments of the disclosure;

FIG. 4 is a view for describing another embodiment of determining a position coordinate and a stop type of a vehicle positioned in the getting off according to embodiments of the disclosure;

FIG. 5 is a view for describing an embodiment of setting a driving path from a station infrastructure to a parking infrastructure according to embodiments of the disclosure;

FIG. 6 is a view for describing an embodiment of setting a discharge path from a parking infrastructure to a departure infrastructure according to embodiments of the disclosure; and

FIG. 7 is a flowchart illustrating a method of controlling a vehicle according to embodiments of the disclosure.

### DETAILED DESCRIPTION

Hereinafter, embodiments of the disclosure will be described in detail with reference to the accompanying drawings. It will be understood that, although the terms first, second, A, B, (a), (b) etc. may be used herein to describe various components, these components should not be limited by these terms. These terms are only used to distinguish one component from another. For example, without departing from the scope of the disclosure; the first component may be referred to as a second component, and similarly, the second component may also be referred to as a first component. Throughout this specification, when a portion is connected to another portion, this includes the case in which the portion is indirectly connected to the other portion, as well as the case in which the portion is directly connected to the other portion, and the indirect connection includes a connection through a wireless communication network.

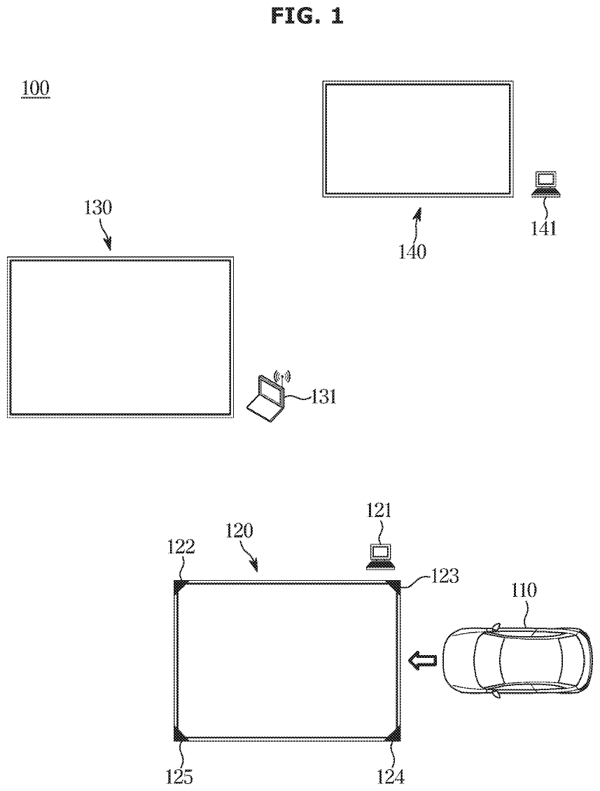

FIG. 1 is a view illustrating a vehicle control system according to embodiments of the disclosure.

Referring to FIG. 1, a vehicle control system 100 may include a vehicle 110, a station infrastructure 120, a parking infrastructure 130, and the like.

The vehicle 110 may include all vehicles regardless of the vehicle type, and may include a motorcycle, a bicycle, and the like. The vehicle 110 may refer to a vehicle capable of autonomous driving in the station infrastructure 120, the parking infrastructure 130, and the like. The vehicle 110 may include a sensor, a vehicle control device, a driving device, and the like.

The station infrastructure 120 may refer to a structure having a certain station area so that the vehicle 110 may enter and stop in the station infrastructure 120.

The station infrastructure 120 may be in various types. For example, the form of station infrastructure 120 may have the station area defined by edges as illustrated in FIG. 1 and may be generally rectangular in shape. However, the disclosure is not limited thereto, and the station infrastructure 120 may have a circular shape, a rhombus, or the like.

Although not illustrated, a grid line indicated to easily detect the position coordinates of the vehicle 110 may be displayed in the station area of the station infrastructure 120.

The station infrastructure 120 may include a first wireless communication device 121 and one or more sensors 122, 123, 124, 125, and the like.

The first wireless communication device 121 may wirelessly communicate with the vehicle 110 to transmit information including the position coordinates of the vehicle 110 and a stop form when the vehicle 110 is positioned in the station infrastructure 120, etc. to the vehicle 110. The first wireless communication device 121 may transmit driving information, position information, status information, etc. necessary for controlling the vehicle 110 to the vehicle 110.

Wireless communication may use all communication technologies such as Long-Term Evolution (LTE), 5th Generation (5G), vehicle to everything communication (V2X), Bluetooth, and the like.

In the disclosure, the V2X may mean that the vehicle 110 exchanges information with an object such as an adjacent vehicle, a mobile device, and a road through a wired or wireless network or a technology thereof. The V2X may include Vehicle to Vehicle (V2V), Vehicle to Infrastructure (V21), Vehicle to Nomadic Device (V2N), and Vehicle to Pedestrian (V2P), etc., mainly the V2N communication can be used in the disclosure.

The V2X is based on Dedicated Short Range Communications (DSRC), and may be realized an IEEE 802.11p communication technology using Wireless Access in Vehicular Environment (WAVE) or 5.9 GHz band recently conducted by the Institute of Electrical and Electronics Engineers (IEEE), but is not limited thereto. It should be understood that the V2X includes all inter-vehicle communications to be developed now or in the future.

The first wireless communication device 121 may be, for example, a set-top box, a beacon, or the like. However, it is not limited thereto.

The one or more sensors 122, 123, 124, and 125 may calculate the position coordinates, which are positions of vehicles 110 positioned within station infrastructure 120. Accordingly, each of the one or more sensors 122, 123, 124, and 125 may previously store the position coordinates disposed in the station infrastructure 120 as necessary.

As illustrated in FIG. 1, the one or more sensors 122, 123, 124, and 125 may be disposed at one corner of the station infrastructure 120 to detect all of the front, side, and rear surfaces of the vehicle 110. Here, when the front, side, and rear surfaces of the vehicle 110 can detect all, the number of sensors is not limited by the bar disclosed in FIG. 1.

The one or more sensors 122, 123, 124, and 125 may be at least one of an image sensor and a non-image sensor.

The image sensor (not shown) may be disposed in the station infrastructure 120 and capture image data to have a view into an interior and exterior of the station infrastructure 120.

There may be more than one image sensor, and at least one image sensor may be mounted in a specific portion of station infrastructure 120 to have a view of the front, side, or rear of the vehicle 110. Here, the specific portion of the station infrastructure 120 may refer to, for example, the corner of the station infrastructure 120. However, it is not limited thereto.

Since image information captured from the image sensor is composed of image data, the image information may refer to the image data captured from the image sensor. Hereinafter, in the disclosure, the image information captured from the image sensor may refer to the image data captured from the image sensor.

The image data captured by the image sensor may be generated, for example, in one of AVI, MPEG-4, H.264, DivX, and JPEG in raw form. The image data captured by the image sensor may be processed by a processor (not shown) included in the image sensor.

The non-image sensor (not shown) may be disposed in the vehicle 110 to have a detecting area for the exterior of the vehicle 110 and configured to capture detecting data.

There may be at least one non-image sensor, and examples of the plurality of non-image sensors may include a RADAR, a LIDAR, an ultrasonic sensor, and the like.

The detecting data captured by the non-image sensor may be processed by a processor (not shown) included in the non-image sensor.

At least one of the image sensor and the non-image sensor may be disposed in the station infrastructure 120.

When the vehicle 110 enters the station infrastructure 120 and is positioned in the station infrastructure 120, a driver who boards the vehicle 110 may transmit a driving command signal using a wireless communication terminal after getting off.

Here, the wireless communication terminal may refer to all devices capable of wireless communication, such as a smart phone and a smart key. The driving command signal may refer to a signal for instructing the vehicle 110 positioned in the station infrastructure 120 to drive and park in the parking infrastructure 130.

The parking infrastructure 130 may refer to the structure having a certain parking area so that the vehicle 110 may enter and park in the parking infrastructure 130.

The parking infrastructure 130 may be in various types. For example, the form of parking infrastructure 130 may have the parking area defined by edges as illustrated in FIG. 1 and may be generally rectangular in shape. However, the disclosure is not limited thereto, and the parking infrastructure 130 may have the circular shape, the rhombus, or the like.

Although not illustrated, the grid line marked to easily detect the position coordinates of the vehicle 110 may be displayed in the parking area of the parking infrastructure 130.

The parking infrastructure 130 may include a second wireless communication device 131 or the like.

The second wireless communication device 131 may wirelessly communicate with the vehicle 110 to transmit information including the position coordinates of the parking infrastructure 130, a type of the parking infrastructure 130, and the like to the vehicle 110. The second wireless communication device 131 may transmit the driving information, the position information, the status information, etc. necessary for controlling the vehicle 110 to the vehicle 110.

In addition, when the vehicle 110 parks in the parking infrastructure 130, similar to the first wireless communication device 121 described above, the second wireless communication device 131 may transmit the position coordinates and a parking type of the vehicle 110 in the parking infrastructure 130 to the vehicle 110.

The second wireless communication device 131 may be, for example, the beacon, the set-top box, or the like, but is not limited thereto.

Although not illustrated, the parking infrastructure 130, like the station infrastructure 120, the grid line indicated to easily detect the position coordinates of the vehicle 110 may be displayed in the station area of the station infrastructure 120.

On the other hand, when the vehicle 10 is parked in the parking infrastructure 10, the driver may transmit a departure command signal using the wireless communication terminal.

The departure command signal may refer to a signal for instructing the vehicle 110 positioned in the parking infrastructure 130 to exit and be positioned in the departure infrastructure 140.

The departure infrastructure 140 is the structure having a certain departure area so that the parked vehicle 210 can exit and the driver can board. The departure infrastructure 140 is illustrated as a separate structure positioned differently from the station infrastructure 120 in FIG. 1, but may be the same structure as the station infrastructure 120.

In addition, the departure infrastructure 140 may have various types, and may include a third wireless communication device 141, a plurality of sensors, and the like.

The third wireless communication device 141 may wirelessly communicate with the vehicle 110 to transmit information including the position coordinates of the departure infrastructure 140, the type the departure infrastructure 140, and the like to the vehicle 110. The third wireless communication device 141 may transmit the driving information, the position information, the status information, etc. necessary for controlling the vehicle 110 to the vehicle 110.

The third wireless communication device 141 may be, for example, the set-top box, the beacon, or the like. However, it is not limited thereto.

When the vehicle 110 receives the departure command signal, the vehicle 110 may autonomously drive along the departure path set from the parking infrastructure 130 to the departure infrastructure 140 to reach the departure infrastructure 140.

The vehicle 110 may park in the parking infrastructure 130 by driving along a driving path set using the position coordinates of the vehicle 110 and the position coordinates of the parking infrastructure 130 that enter and stop the station infrastructure 120. The vehicle 110 may enter the parking infrastructure 130 and drive along the departure path set using the position coordinates of the vehicle 110 and the position coordinates of the departure infrastructure 140 to reach the departure infrastructure 140.

The above description may be implemented through a vehicle control apparatus mounted in the vehicle 110. Hereinafter, the vehicle control apparatus according to the disclosure will be described in detail.

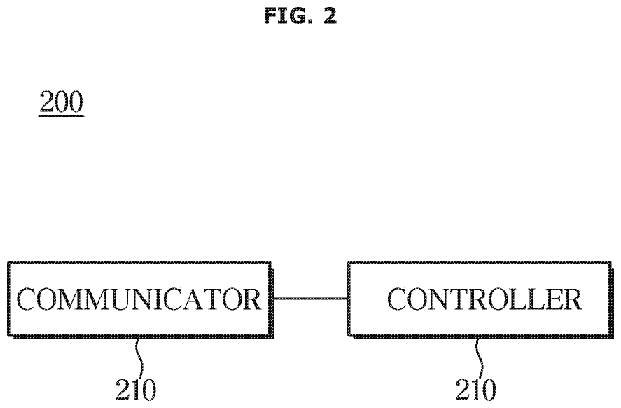

FIG. 2 is a view illustrating a configuration of a vehicle control apparatus according to embodiments of the disclosure.

Referring to FIG. 2, a vehicle control device 220 may include a communicator 210, a controller 220, and the like.

The communicator 210 may receive first information of the vehicle 110 that are stopped in the station infrastructure 120 and second information of the parking infrastructure 130.

The first information may include the position coordinates and the stop type of the vehicle 110 present in the station infrastructure 120 obtained by a processing result of at least one of the image data captured by the image sensor and the detecting data captured by the non-image sensor. In this case, at least one of the image sensor and the non-image sensor may be disposed in the station infrastructure 120.

The stop type may refer to the stop forms of the vehicle 110 positioned in the station infrastructure 120. The stop type may be, for example, a longitudinal stop where the vehicle 110 stops to correspond to a longitudinal direction, a transverse stop where the vehicle 110 stops to correspond to a transverse direction, and a diagonal line directional stop where the vehicle 110 stops at a constant angle with the station infrastructure 120, and the like. However, it is not limited thereto. In this case, the longitudinal stop and the transverse stop may be relative determined according to a specific reference.

In addition, the first information may refer to information transmitted to the communicator 210 by the first wireless communication device 121 disposed in the station infrastructure 120.

The second information may include the position coordinates of the parking infrastructure 130, the type of the parking infrastructure 130, and the like. In addition, the second information may refer to information transmitted to the communicator 210 by the second wireless communication device 131 disposed in the parking infrastructure 130.

The controller 140 may set the driving path from the station infrastructure 120 to the parking infrastructure 130 based on the first information and the second information, determine an initial behavior when the vehicle 110 stopped in the station infrastructure 120 starts based on the first information, and control the vehicle 110 stopped in the stopped in the station infrastructure 120 to drive along the driving path and park the vehicle 110 in the parking infrastructure 130.

Here, the initial behavior may refer to a movement when the vehicle 110 positioned in the station infrastructure 120 first starts. The initial behavior may refer to, for example, a steering angle of the vehicle 110, a degree of acceleration, forward, backward, direction indicators, and the like. However, it is not limited thereto.

Here, the driving path may refer to a path that is set such that the vehicle 110 110 starts from the station infrastructure 120 and reaches the parking infrastructure 130. The driving path may be set using the position coordinates of the vehicle 110 and the position coordinates of the parking infrastructure 130.

That is, the controller 140 may set the position coordinates of the vehicle 110 included in the first information as a starting point, set the position coordinates of the parking infrastructure 130 included in the second information as an arrival point, and set the driving path from the starting point to the arrival point.

As described above, when the vehicle 110 stops at the station infrastructure 120 120, the driver who boards the vehicle 110 may transmit the driving command signal using the wireless communication terminal after getting off.

At this time, when the controller 140 receives the driving command signal, the controller 140 may control the vehicle 110 such that the vehicle 110 autonomously drives along the driving path set from the station infrastructure 120 to the parking infrastructure 130 and parks in the parking infrastructure 130.

For example, when the controller 140 receives the driving command signal from the wireless communication terminal, the controller 140 may control the vehicle 210 to drive along the driving path.

Meanwhile, when the vehicle 110 parks in the parking infrastructure 130, the driver may instruct the vehicle 110 to move from the parking infrastructure 130 to the departure infrastructure 140.

Particularly, the communicator 210 may receive third information including position coordinates of the departure infrastructure 140 from the third wireless communication device 141 disposed in the departure infrastructure 140.

In this case, when the vehicle 110 completes parking in the parking infrastructure 130, the controller 140 may determine whether to receive the departure command signal generated by the wireless communication terminal. When the vehicle 110 receives the departure command signal, the controller 140 may set the departure path from the parking infrastructure 130 to departure infrastructure 140 using the position coordinates of the parking infrastructure 130 included in the second information and the position coordinates of the departure infrastructure 140 included in the third information, and may control the vehicle 110 parked in the parking infrastructure 130 to exit along the departure path.

The controller 140 may be implemented using an Electronic Controller Unit (ECU), a Micro Controller Unit (MCU), or the like.

The driving path may be set using the position of the vehicle 110 in the station infrastructure 120, and the departure path may be set using the position of the vehicle 110 in the parking infrastructure 130.

Hereinafter, an embodiment of determining the position of the vehicle 110 in the station infrastructure 120 will be described in detail.

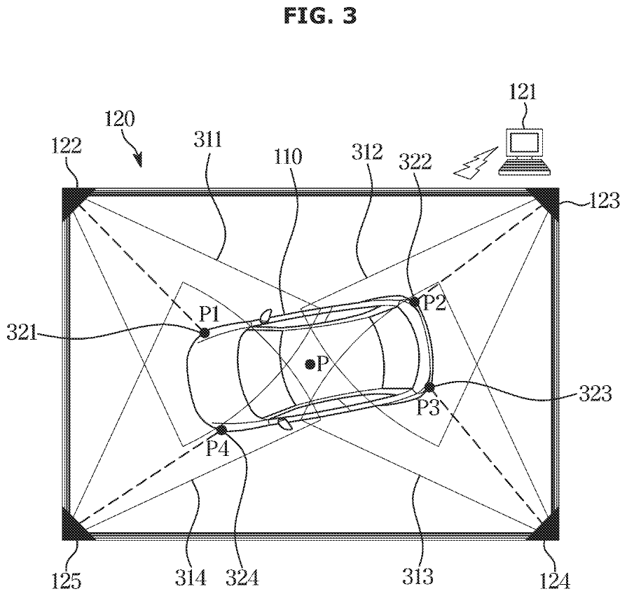

FIG. 3 is a view for describing an embodiment of determining position coordinates and a stop type of a vehicle positioned in a station infrastructure according to embodiments of the disclosure.

As described above, the controller 140 may set the position coordinates of the vehicle 110 included in the first information as the starting point, and set the position coordinates of the parking infrastructure 130 included in the second information as the arrival point. Since the driving path is set the driving path from the starting point to the arrival point, it is important to determine the position coordinates of the vehicle 110.

Referring to FIG. 3, when the vehicle 110 is positioned in the station infrastructure 120, the position coordinates of the vehicle 110 in the station infrastructure 120 may be determined using a plurality of sensors 122, 123, 124, and 125 disposed in the station infrastructure 120.

The plurality of sensors 122, 123, 124, and 125 are disposed at corners of the station infrastructure 120 as illustrated in FIG. 3, but are not limited thereto. When all of the front, side, and rear surfaces of the vehicle 110 can be detected. The arrangement in the station infrastructure 120 is irrelevant.

For example, when the plurality of sensors 122, 123, 124, and 125 are four image sensors, the four image sensors may capture the image data of each of the front, left, right, and rear surfaces of the vehicle 110 and process the captured image data.

A first image sensor of the plurality of image sensors may obtain a first portion 321 of the vehicle 110 from the processing result of a first image data captured in a first detecting area 311 of the first image sensor and calculate a distance between the first image sensor and the first portion 321.

Then, the first image sensor may separate the distance between the first image sensor and the first portion 321 into x and y components, and may calculate a first coordinate P1 by reflecting the distance between the first image sensor and the first portion 321 separated into the x and y components in the pre-stored position coordinates of the first image sensor.

Similar to the foregoing, a second image sensor of the plurality of image sensors may obtain a second portion 322 of the vehicle 110 from the processing result of a second image data captured in a second detecting area 312 of the second image sensor and calculate the distance between the second image sensor and the second portion 322.

Then, the second image sensor may separate the distance between the second image sensor and the second portion 322 into x and y components, and may calculate a second coordinate P2 by reflecting the distance between the second image sensor and the second portion 322 separated into the x and y components in the pre-stored position coordinates of the second image sensor.

As described above, a third image sensor and a fourth image sensor may calculate a third coordinate P3 and a fourth coordinate P4 for each of a third portion 323 and a fourth portion 324 of the vehicle 110, respectively.

At least one of the plurality of image sensors 110 may calculate a center coordinate P of the vehicle 110 using the calculated first coordinate P1, the second coordinate P2, the third coordinate P3, and the fourth coordinate P4. In addition, the center coordinate P may be determined as position coordinates of the vehicle 110.

On the other hand, the above embodiment has been described with reference to the plurality of image sensors 110, it can be implemented in the same manner using a plurality of non-image sensors.

In addition, the above-described embodiment may be applied to the parking infrastructure 130.

When the position coordinates of the vehicle 110 are determined by the plurality of sensors 122, 123, 124, and 125, the plurality of sensors 122, 123, 124, and 125 may output the first information including the position coordinates of the vehicle 110 to the first wireless communication device 121. The first wireless communication device 121 may transmit the first information to the vehicle 110.

Meanwhile, the plurality of sensors 122, 123, 124, and 125 may determine the stop type of the stopped vehicle 110 in the station infrastructure 120 according to a turning angle, and output the first information including the determined stop type to the first wireless communication device 121. The first wireless communication device 121 may transmit the first information to the vehicle 110.

That is, the first information may include the stop type determined by any one of the longitudinal stop, the transverse stop and a diagonal stop according to the turning angle of the vehicle 110 with respect to the station infrastructure 120 obtained by the processing result of at least one of the image data captured by the image sensor and the detecting data captured by the non-image sensor.

For example, when the plurality of sensors 122, 123, 124, and 125 are four image sensors, the first image sensor of the plurality of image sensors may obtain a distortion degree of the first portion 321 of the vehicle 110 from the processing result of the first image data and calculate a first turning angle through image processing of the distortion degree of the first portion 321.

As described above, the second image sensor may obtain the distortion degree of the second portion 322 of the vehicle 110, and thereby calculate a second turning angle. As described above, the third image sensor and the fourth image sensor may calculate the turning angles, respectively.

When the turning angle is calculated, the plurality of sensors may determine any one of the longitudinal stop, the transverse stop and the diagonal stop according to the turning angle of the vehicle 110.

For example, when the turning angle is included between 0 and a predetermined first reference angle, the plurality of image sensors may determine the stop type as the transverse stop (or longitudinal stop). When the turn angle is included between the first reference angle and a predetermined second reference angle, the plurality of image sensors may determine the stop type as the diagonal stop. When the turning angle is included between the second reference angle and 90 degrees, the plurality of image sensors may determine the stop type as the longitudinal stop (or transverse stop).

When the stop type included in the first information is determined, the controller 140 may determine the initial behavior (e.g., steering angle) corresponding to the stop type included in the first information.

On the other hand, the above embodiment has been described with reference to the plurality of image sensors 110, it can be implemented in the same manner using a plurality of non-image sensors.

In addition, the above-described embodiment may be applied to the parking infrastructure 130.

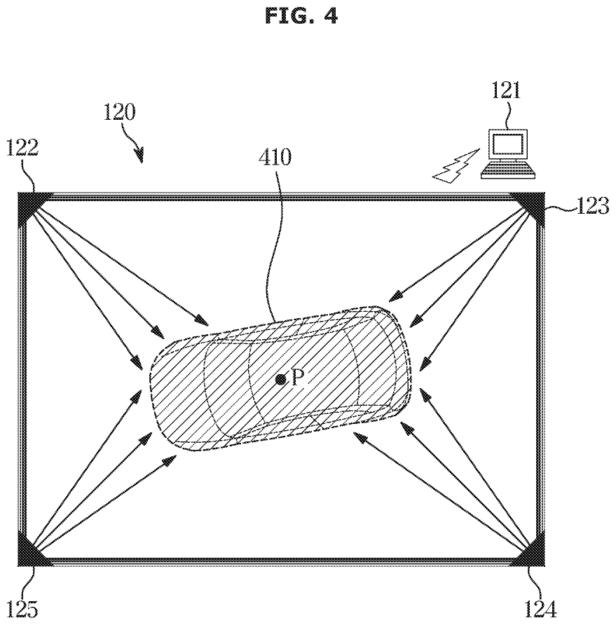

FIG. 4 is a view for describing another embodiment of determining a position coordinate and a stop type of a vehicle positioned in the getting off according to embodiments of the disclosure.

Referring to FIGS. 1, 2, and 4, the plurality of sensors 122, 123, 124, and 125 disposed in the station infrastructure 120 may obtain a vehicle area 410 that the vehicle 110 occupies within the station infrastructure 120 using the distance between each of the front, side, and rear surfaces of the vehicle 110 and the plurality of sensors 122, 123, 124, and 125, and calculate the position coordinates and output the first information to the first wireless communication device 121. The first wireless communication device 121 may transmit the first information to the vehicle 110.

That is, the first information may include the position coordinates of the vehicle 110 calculated using intervals between at least one of the image sensor and the non-image sensor obtained by a processing result of at least one of the image data captured by the image sensor and the detecting data captured by the non-image sensor and the vehicle 110 and the vehicle area 410 that the vehicle 110 occupies within the station infrastructure 120.

Thus, in the image sensor disposed in the station infrastructure 120 and capturing the image data, the image data may be used to generate information including the position coordinates of the vehicle 110 calculated using the distance between the image sensor and the vehicle 110 and the vehicle area 410 that the vehicle 110 occupies within the station infrastructure 120 and the stop type determined by any one of the longitudinal stop, the transverse stop and the diagonal stop according to the turning angle of the vehicle 110 with respect to the station infrastructure 120.

On the other hand, the above embodiment has been described with reference to the plurality of image sensors 110, it can be implemented in the same manner using a plurality of non-image sensors.

In addition, the above-described embodiment may be applied to the parking infrastructure 130.

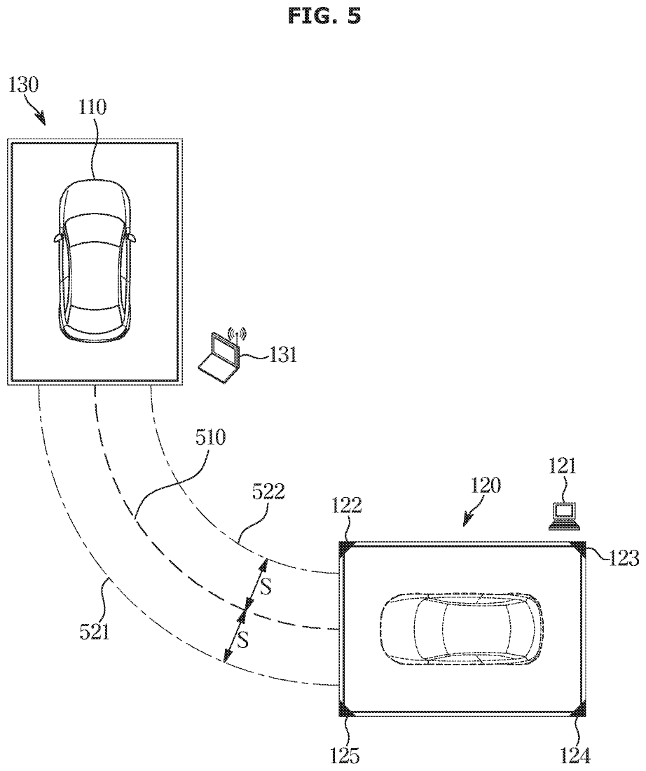

FIG. 5 is a view for describing an embodiment of setting a driving path from a station infrastructure to a parking infrastructure according to embodiments of the disclosure.

Referring to FIG. 5, the controller 140 may set a driving path 510 using the position coordinates of the vehicle 110 in the station infrastructure 120 included in the first information and the position coordinates of the parking infrastructure 130 included in the second information.

Here, the controller 140 may set a plurality of collision avoidance boundary lines 521 and 522 spaced apart by a predetermined safety distance s from the width of the driving path 510 based on the driving path 510.

For example, the controller 140 may set a first collision avoidance boundary line 521 spaced apart by the safety distance s in a first direction of the width of the driving path 510 and a second collision avoidance boundary line 522 spaced apart by the safety distance s in a second direction of the width of the driving path 510.

Here, the first collision avoidance boundary line 521 and the second collision avoidance boundary line 522 may be the same or different in length, curvature, etc. according to the surrounding environment of the vehicle 110.

Next, the controller 140 may control the behavior of the vehicle 110 such that the vehicle 110 driving along the driving path 510 does not leave the plurality of collision avoidance boundary lines 521 and 522.

For example, when the vehicle 110 deviates from the first collision avoidance boundary line 521, the controller 140 may control the steering of the vehicle 110 such that the vehicle 110 may further turn right to drive along the driving path 510. However, it is not limited thereto.

Although not illustrated, since obstacles may exist on the driving path 510, the controller 140 may update the position coordinates of the parking infrastructure 130 from the second information received while the vehicle 110 is driving, and may correct the driving path 510 based on the updated the position coordinates of the parking infrastructure 130. The controller 140 may set a local path (not shown) based on a possibility of collision with the obstacle when vehicle 110 drives along the driving path 510.

Although not illustrated, when the second information includes the shape and size of the parking infrastructure 130, the controller 140 may determine the parking type of the vehicle 110, such as parallel parking and diagonal parking, by extracting the shape and size of the parking infrastructure 130 included in the second information.

Hereinafter, an embodiment of setting the departure path from the parking infrastructure 130 to the departure infrastructure 140 will be described.

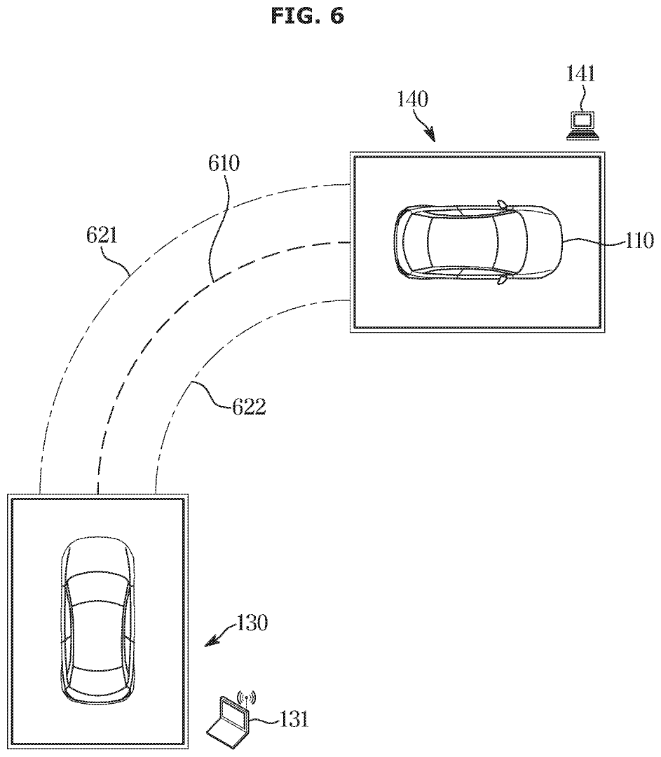

FIG. 6 is a view for describing an embodiment of setting a discharge path from a parking infrastructure to a departure infrastructure according to embodiments of the disclosure.

Referring to FIGS. 2 and 6, the communicator 210 may receive the third information including the position coordinates of the departure infrastructure 140 from the third wireless communication device 131 disposed in the departure infrastructure 140.

In this case, when the vehicle 110 completes parking in the parking infrastructure 130, the controller 140 may determine whether to receive the departure command signal generated by the wireless communication terminal.

When receiving the departure command signal, the controller 140 may set a departure path 610 from the parking infrastructure 130 to the departure infrastructure 140 using the position coordinates of the parking infrastructure 130 included in the second information and the position coordinates of the departure infrastructure 140 included in the third information in the parking infrastructure 130.

The position coordinates of the vehicle 110 in the parking infrastructure 130 may be determined in the same manner as the method of determining the position coordinates of the vehicle 110 in the station infrastructure 120 described above with reference to FIGS. 3 and 4.

When the departure path 610 is set, it is necessary to set the initial behavior when the vehicle 110 first departs from the parking infrastructure 130. The initial behavior when the vehicle 110 first starts may be determined according to the parking type of the vehicle 120 parked in the parking infrastructure 130 as described above. The method of determining the parking type may be the same as the method of determining the stop type described above with reference to FIGS. 3 and 4.

Next, the vehicle 110 parked in the parking infrastructure 130 may be controlled to exit along the departure path 610.

Although not illustrated, as illustrated in FIG. 5, the controller 140 may set the plurality of anti-collision boundary lines spaced apart by a predetermined safety distance in both directions of the width of the departure path 810.

Although not shown, as shown in FIG. 5, the controller 140 may set the plurality of collision avoidance boundary lines spaced apart by the predetermined safety distance in both directions of the width of the departure path 610.

Hereinafter, a vehicle control method capable of performing all of the disclosure will be described in detail.

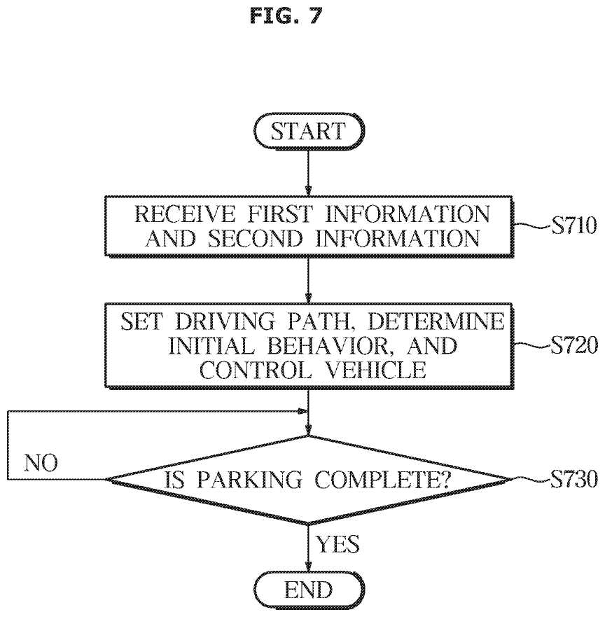

FIG. 7 is a flowchart illustrating a method of controlling a vehicle according to embodiments of the disclosure.

Referring to FIG. 7, the vehicle control method may include an operation S710, an operation S720, and the like. In the operation S710, the communicator 210 may receive the first information of the vehicle 110 stopped in the station infrastructure 120 and the second information of the parking infrastructure 130. In the operation S720, the controller 140

In the second step, the controller 140 may set the driving path 510 from the station infrastructure 120 to the parking infrastructure 130 based on the first information and the second information, determine the initial behavior when the stopped vehicle 110 starts based on the first information, and control the vehicle 110 stopped in the station infrastructure 120 to drive along the driving path 510 to park in the parking infrastructure 130.

Here, the vehicle control method may further include an operation S730 of determining whether the vehicle 110 parked in the parking infrastructure 130. That is, when the parking is not completed, the operation S720 is performed, and when the parking is completed, the operation terminates.

In the first information, as described above with reference to FIG. 2, at least one of the image sensor and the non-image sensor is disposed in the station infrastructure 120. The first information may include the position coordinates and the stop type of the vehicle 110 present in the station infrastructure 120 obtained by a processing result of at least one of the image data captured by the image sensor and the detecting data captured by the non-image sensor. The first information may be transmitted to the communicator 210 by the first wireless communication device 121 disposed in the station infrastructure 120.

Here, the second information may include the position coordinates of the parking infrastructure 130, the type of the parking infrastructure 130, and the like. The second information may be transmitted to the communicator 210 by the second wireless communication device 131 disposed in the parking infrastructure 130.

The controlling of parking to the parking infrastructure 130 (S720) may set the position coordinates of the vehicle 110 included in the first information as the starting points, set the position coordinates of the parking infrastructure 130 included in the second information as the arrival point, and set the driving path from the starting point to the arrival point.

In this case, the first information may include the position coordinates of the vehicle 110 calculated using intervals between at least one of the image sensor and the non-image sensor obtained by the processing result of at least one of the image data captured by the image sensor and the detecting data captured by the non-image sensor and the vehicle 110 and the vehicle area 410 that the vehicle 110 occupies within the station infrastructure 120.

The controlling of parking to the parking infrastructure 130 (S720) may determine the initial behavior corresponding to the stop type included in the first information.

In this case, the first information may include the stop type determined by any one of the longitudinal stop, the transverse stop and the diagonal stop according to the turning angle of the vehicle 110 with respect to the station infrastructure 120 obtained by the processing result of at least one of the image data captured by the image sensor and the detecting data captured by the non-image sensor.

According to an aspect of the disclosure as described above, it is possible to provide the vehicle control apparatus capable of providing driving convenience to a driver by controlling a vehicle to park autonomously, and the method of controlling the vehicle.

In addition, according to another aspect of the disclosure, it is possible to provide the vehicle control apparatus capable of setting a driving path for accurately parking a parking area or a departure path for accurately reaching a departure area, and the method of controlling the vehicle.

The description above and the accompanying drawings are merely illustrative of the technical spirit of the disclosure, and a person of ordinary skill in the art to which the disclosure pertains will be able to make various modifications and variations such as combining, separating, substituting and changing the configurations without departing from the essential characteristics of the disclosure. Accordingly, the disclosed embodiments are not intended to limit the technical spirit of the disclosure but to describe the scope of the technical spirit of the disclosure, That is, within the scope of the disclosure, all of the components may be operated in a selective combination with one or more. The protection scope of the disclosure should be interpreted by the following claims, and all technical ideas within the scope equivalent thereto shall be construed as being included in the scope of the disclosure.

What is claimed is:

1. A vehicle control apparatus comprising:
a communicator configured to receive first information of a vehicle stopped in a station infrastructure and second information of a parking infrastructure; and
a controller configured to:
set a driving path from the station infrastructure to the parking infrastructure based on the first information and the second information;
determine an initial behavior when the vehicle stopped in the station infrastructure starts based on the first information; and
control the vehicle stopped in the station infrastructure to drive along the driving path and park in the parking infrastructure,
wherein the first information comprises position coordinates and a stop type of the vehicle obtained by a processing result of at least one of image data captured by an image sensor disposed in the station infrastructure and detecting data captured by a non-image sensor disposed in the station infrastructure, and is configured to be transmitted to the communicator by a first wireless communication device disposed in the station infrastructure, and
wherein the second information comprises position coordinates of the station infrastructure and a type of the station infrastructure, and is configured to be transmitted to the communicator by a second wireless communication device disposed in the parking infrastructure.

2. The vehicle control apparatus according to claim 1, wherein the controller is configured to:
set the position coordinates of the vehicle included in the first information as a starting point;
set the position coordinates of the parking infrastructure included in the second information as an arrival point; and
set the driving path from the starting point to the arrival point.

3. The vehicle control apparatus according to claim 2, wherein the first information comprises the position coordinates of the vehicle calculated using intervals between at least one of the image sensor and the non-image sensor obtained by the processing result of at least one of the image data captured by the image sensor and the detecting data captured by the non-image sensor and the vehicle and the vehicle area that the vehicle occupies within the station infrastructure.

4. The vehicle control apparatus according to claim 1, wherein the first information comprises the stop type determined by any one of a longitudinal stop, a transverse stop and a diagonal stop according to a turning angle of the vehicle with respect to the station infrastructure obtained by the processing result of at least one of the image data captured by the image sensor and the detecting data captured by the non-image sensor, and
wherein the controller is configured to determine the initial behavior corresponding to the stop type included in the first information.

5. The vehicle control apparatus according to claim 1, wherein the controller is configured to control the vehicle to drive along the driving path when a driving command signal is received from a wireless communication terminal.

6. The vehicle control apparatus according to claim 1, wherein the controller is configured to:
update the position coordinates of the parking infrastructure from the second information received while the vehicle is driving;
correct the driving path based on the updated the position coordinates of the parking infrastructure; and
set a local path based on a possibility of collision with an obstacle when the vehicle drives along the driving path.

7. The vehicle control apparatus according to claim 1, wherein the communicator is configured to receive third information including position coordinates of a departure infrastructure from a third wireless communication device disposed in the departure infrastructure, and
wherein the controller is configured to:
when the vehicle completes parking in the parking infrastructure, determine whether to receive a departure command signal generated by the wireless communication terminal;
when the vehicle receives the departure command signal, set a departure path from the parking infrastructure to the departure infrastructure using the position coordinates of the parking infrastructure included in the second information and the position coordinates of the departure infrastructure included in the third information; and
control the vehicle parked in the parking infrastructure to exit along the departure path.

8. The vehicle control apparatus according to claim 1, wherein the controller is configured to:
set a plurality of collision avoidance boundary lines spaced apart by a predetermined safety distance from the width of the driving path based on the driving path; and
control the behavior of the vehicle such that the vehicle driving along the driving path drives within a range of the plurality of collision avoidance boundary lines.

9. The vehicle control apparatus according to claim 1, wherein the image data is configured to be used to generate information including the position coordinates of the vehicle calculated using the distance between the image sensor and the vehicle and the vehicle area that the vehicle occupies within the station infrastructure and the stop type determined by any one of the longitudinal stop, the transverse stop and the diagonal stop according to the turning angle of the vehicle with respect to the station infrastructure.

10. The vehicle control apparatus according to claim 1, wherein the image sensor comprises a plurality of image sensors provided at each corner of the station infrastructure, and
wherein the first information comprises the position coordinates and the stop type of the vehicle present in the station infrastructure obtained by the processing result of image data captured by the plurality of image sensors.

11. A method of controlling a vehicle comprising:
receiving, by a communicator, first information of a vehicle stopped in a station infrastructure and second information of a parking infrastructure;
setting, by a controller, a driving path from the station infrastructure to the parking infrastructure based on the first information and the second information;
determining, by the controller, an initial behavior when the vehicle stopped in the station infrastructure starts based on the first information; and
controlling, by the controller, the vehicle stopped in the station infrastructure to drive along the driving path and park in the parking infrastructure,
wherein the first information comprises position coordinates and a stop type of the vehicle obtained by a processing result of at least one of image data captured by an image sensor disposed in the station infrastructure and detecting data captured by a non-image sensor disposed in the station infrastructure, and is configured to be transmitted to the communicator by a first wireless communication device disposed in the station infrastructure, and
wherein the second information comprises position coordinates of the station infrastructure and a type of the station infrastructure, and is configured to be transmitted to the communicator by a second wireless communication device disposed in the parking infrastructure.

12. The method according to claim 11, wherein the controlling of the vehicle to park in the parking infrastructure comprises:
setting the position coordinates of the vehicle included in the first information as a starting point;
setting the position coordinates of the parking infrastructure included in the second information as an arrival point; and
setting the driving path from the starting point to the arrival point.

13. The method according to claim 12, wherein the first information comprises the position coordinates of the vehicle calculated using intervals between at least one of the image sensor and the non-image sensor obtained by the processing result of at least one of the image data captured by the image sensor and the detecting data captured by the non-image sensor and the vehicle and the vehicle area that the vehicle occupies within the station infrastructure.

14. The method according to claim 11, wherein the first information comprises the stop type determined by any one of a longitudinal stop, a transverse stop and a diagonal stop according to a turning angle of the vehicle with respect to the station infrastructure obtained by the processing result of at least one of the image data captured by the image sensor and the detecting data captured by the non-image sensor, and
wherein the controlling of the vehicle to park in the parking infrastructure comprises:
determining the initial behavior corresponding to the stop type included in the first information.

15. The method according to claim 11, wherein the controlling of the vehicle to park in the parking infrastructure comprises:
controlling the vehicle to drive along the driving path when a driving command signal is received from a wireless communication terminal.

16. The method according to claim 11, wherein the controlling of the vehicle to park in the parking infrastructure comprises:
updating the position coordinates of the parking infrastructure from the second information received while the vehicle is driving;
correcting the driving path based on the updated the position coordinates of the parking infrastructure; and
setting a local path based on a possibility of collision with an obstacle when the vehicle drives along the driving path.

17. The method according to claim 11, further comprising:
receiving, by the communicator, third information including position coordinates of a departure infrastructure from a third wireless communication device disposed in the departure infrastructure;
when the vehicle completes parking in the parking infrastructure, determining, by the controller, whether to receive a departure command signal generated by the wireless communication terminal;
when the vehicle receives the departure command signal, setting, by the controller, a departure path from the parking infrastructure to the departure infrastructure using the position coordinates of the parking infrastructure included in the second information and the position coordinates of the departure infrastructure included in the third information; and
controlling, by the controller, the vehicle parked in the parking infrastructure to exit along the departure path.

18. The method according to claim 11, wherein the controlling of the vehicle to park in the parking infrastructure comprises:
setting a plurality of collision avoidance boundary lines spaced apart by a predetermined safety distance from the width of the driving path based on the driving path; and
controlling the behavior of the vehicle such that the vehicle driving along the driving path drives within a range of the plurality of collision avoidance boundary lines.

19. The method according to claim 11, wherein the image data is configured to be used to generate information including the position coordinates of the vehicle calculated using the distance between the image sensor and the vehicle and the vehicle area that the vehicle occupies within the station infrastructure and the stop type determined by any one of the longitudinal stop, the transverse stop and the diagonal stop according to the turning angle of the vehicle with respect to the station infrastructure.

20. The vehicle control apparatus according to claim 11, wherein the image sensor comprises a plurality of image sensors provided at each corner of the station infrastructure, and
wherein the first information comprises the position coordinates and the stop type of the vehicle present in the station infrastructure obtained by the processing result of image data captured by the plurality of image sensors.
